(19) United States
(12) Patent Application Publication
(10) Pub. No.: US 2010/0282878 A1
(43) Pub. Date: Nov. 11, 2010

(54) APPARATUS, SYSTEM AND METHOD FOR SHREDDING PLASTERBOARD

(76) Inventor: Sean Thomas Hallard, Bristol (GB)

Correspondence Address: CARL M. NAPOLITANO, PH.D.;ALLEN, DYER, DOPPELT, MILBRATH & GILCHRIST, P.A., 255 SOUTH ORANGE AVE., SUITE 1401, P.O. BOX 3791, ORLANDO, FL, 32802-3791, US

(21) Appl. No.: 12/668,893

(22) PCT Filed: Jun. 10, 2008
(86) PCT No.: PCT/GB2008/001986

§ 371 Date: Apr. 6, 2010

(30) Foreign Application Priority Data
Jul. 13, 2007 (GB) 0713651.8

(51) Int. Cl. B02C 23/08

(52) U.S. Cl. 241/24.19; 241/83; 241/68

(57) ABSTRACT

This invention provides an apparatus, a system and a method for shredding building materials such as plasterboard, and then processing the shredded waste to recover the constituent materials. The apparatus (10) has at least one opening (13) into which waste plasterboard (16) may be placed and means for shredding the plasterboard placed in the opening (13). The system (48) comprises means for crushing the shredded plasterboard strips (50), means for removing loose gypsum (49) and means for removing waste paper (51). The method comprises the steps of shredding plasterboard into strips (60), removing loose gypsum from the shredded plasterboard strips (61), crushing the plasterboard strips to separate the gypsum from the paper (63) and removing the waste paper (64).

This invention concerns shredding building materials such as plasterboard so that their constituent materials may be more easily separated and then recycled.

Plasterboard, also known as drywall, gypsum board, gibraltar board or gib, is typically composed of an inner core of gypsum plaster sandwiched between two paper sheets. During manufacture, gypsum plaster powder is mixed with a variety of additives and water before being compressed between two paper sheets to which it bonds when drying.

Plasterboard has a number of advantages over other building materials and, as a result, is commonly used throughout the construction industry. As plasterboard is often produced to a standard specification and cut to a desired size at the building site, around 10-15% of the total volume of plasterboard bought for a project is wasted. As plasterboard contains sulphate, it must be disposed of at specially licensed landfill sites. Recent reductions in the number of such sites has increased disposal and waste transportation costs. These costs are forecast to increase further in the future.

Managing waste material at a building site is also costly both in terms of manpower and resources. Collecting large pieces of waste plasterboard manually and disposing of them in commercial skips is a time consuming and labour intensive process.

Notwithstanding the economic disincentives, dumping plasterboard waste in landfill sites has a negative impact on the environment. The sulphate content of the gypsum may react with other materials in a landfill site to produce harmful gas products such as hydrogen sulphide.

To combat some of these problems, incentives to recycle plasterboard so that the constituent components may be reused rather than buried in landfill sites have been created. As a result, schemes have been launched whereby waste plasterboard may be left at municipal dumps and periodically taken away for recycling.

Such schemes do not solve the problem of how to manage waste plasterboard at the building site and transport it to the dump. Large pieces may be awkward to move and may take up large amounts of space. Relocating waste plasterboard is a labour intensive process, particularly when such waste may be situated inside a building site or on a scaffold structure. Waste plasterboard placed inside a skip must be sorted before it can be recycled using the above mentioned scheme and this involves further time and cost. Both labourers and recycling incentive schemes look for more straightforward ways to recycle plasterboard that will reduce costs, resources and manual labour and will encourage a greater volume of plasterboard to be recovered rather than disposed of.

In the above mentioned schemes, once the waste plasterboard is taken away from a municipal dump, it is recycled. WO03/082485 discloses an exemplary plasterboard recycling system for use in such a scheme. Waste plasterboard is placed into a hopper and directed onto a conveyor belt whereupon ferrous materials are removed. The waste plasterboard is transferred into a pulveriser and then onto a mesh screen to separate loose gypsum powder from waste paper. The gypsum is recovered from the paper for reuse.

This is a multistage recycling process wherein the waste must be passed from a hopper to a conveyor belt, from the belt to a pulveriser and finally from the pulveriser to a mesh, before the constituent components are finally separated. Such a multistage process is slow, expensive and liable to mechanical failure. The interaction between each of the stages adds further complexity to the system increasing cost and reducing reliability. As more and more plasterboard is recycled, faster and more reliable systems will be needed to cope with the increasing supply. Systems which are more compact or more conducive to recycling on a production line will be required to allow an increased number of systems to operate in a given space or allow systems to be installed where larger multistage systems could not.

Systems which operate on a single production line are known to increase processing efficiency but rely on regulation of material input to operate effectively. Production line systems tend to require standard sizes or shapes of material to start with to ensure the quality of the end product. Plasterboard waste may come in a variety of shapes and sizes depending on how it has been used and disposed of at the building site. This has necessitated the use of hammer mills or pulverisers of the type taught in WO03/082485 to create a regular supply of material to separate on the mesh. Such apparatuses may be effective at removing gypsum from the paper but these can often disintegrate the paper such that paper particles become mixed with the gypsum powder and the paper cannot be recovered for recycling. An improved system of recycling plasterboard which operates using a single production line and which is more effective at separating and recovering the constituent components of plasterboard waste is therefore desired.

In a first aspect of the invention, an apparatus is provided for shredding plasterboard waste. The apparatus comprises at least one opening, into which waste plasterboard may be placed, and means for shredding the plasterboard placed in the opening. The means for shredding may be situated inside the opening thereby restricting access and reducing risk of injury to an operator.

Preferably, the apparatus further comprises means for attaching the apparatus to a waste receptacle so that shredded plasterboard may be collected therein. The shredded plasterboard may simply be dropped from a second opening in the apparatus into a waste receptacle or, alternatively, directed there by a chute, for example. The means for attaching may be adjustable and may be adjusted to attach the apparatus to different sizes of waste receptacle. Adjustment may be made to the effective length or width of the apparatus, such that it may be placed over a range of sizes of waste receptacle, or to a fastening means with which to attach the apparatus to a side of a waste receptacle, for example.

In one embodiment, the apparatus is configured to be supported over an opening in a waste receptacle. By virtue of the means for attachment, differently sized openings may be accommodated. Alternatively, the apparatus may comprise its own waste receptacle for collecting the shredded plasterboard. This would eliminate the need for a separate waste receptacle. A suitable waste receptacle may be a skip or a wheelie bin, for example.

Preferably, the apparatus further comprises an extractor attachable to a waste receptacle and configured to remove the shredded plasterboard waste to a remote location. The extractor may be a standard dust extractor configured to remove loose gypsum, or a suitable alternative means configured to remove larger materials or all of the shredded plasterboard waste. A chute may be attached to the apparatus and configured to transport the shredded plasterboard waste to a remote location.

Plasterboard is generally provided in a variety of thicknesses and optimal shredding may be achieved by providing openings and shredding means configured to shred particular thicknesses of plasterboard. Preferably, the apparatus comprises a first opening capable of receiving plasterboard having a first thickness and a second opening capable of receiving plasterboard having a second thickness, the second thickness being different to the first thickness. Three, four or more openings may be provided, each opening being configured for a particular thickness of plasterboard. Each opening may be designed to accept plasterboard having a thickness selected from the group of 9.5 mm, 12.5 mm, 15 mm and 19 mm, for example. Alternatively, the width of the openings, and the configuration of the shredding means, may be adjustable to accommodate different thicknesses of plasterboard.

The apparatus may comprise a plurality of openings and a single means for shredding or, alternatively, a separate means for shredding could be provided for each of the plurality of openings.

Preferably, the apparatus is configured to shred the plasterboard into strips. The width of the strips may be between about 2 mm and about 50 mm. Preferably the width of the strips is between about 5 mm and about 30 mm. More preferably the width is between about 9 mm and about 20 mm. Preferably, the width of the shredded plasterboard strips is no greater than the thickness of the plasterboard. If a means for shredding is provided in each of the openings, each means for shredding may be configured to shred the plasterboard into strips of a particular width. The width may be dependent on the thickness of the plasterboard being placed in that opening.

Preferably, the means for shredding may be adjusted to shred the plasterboard into strips of a desired width, the width being manually or automatically selectable.

In one embodiment, the apparatus comprises sensing means for sensing a characteristic of a plasterboard placed in the at least one opening. Depending on the characteristic being sensed, and the value of that characteristic, an action may be triggered. For example, the characteristic may be the thickness of the plasterboard, in which case the apparatus may further comprise a controller configured to activate a warning device if the thickness of the plasterboard is incompatible with the opening in which it is placed.

Alternatively, the apparatus may further comprise a controller configured to adjust the means for shredding such that, upon sensing the thickness of the plasterboard, the means for shredding is adjusted so that it is able to most effectively shred the plasterboard placed in the opening. The means for shredding may be adjusted to accommodate for the thickness of the plasterboard or to automatically shred the plasterboard into strips of a desired width, for example.

In an alternative embodiment, the characteristic may be the composition of the plasterboard, in which case the apparatus may further comprise a controller configured to direct different compositions of plasterboard to different locations or activate a warning device when the composition of the plasterboard is not suitable for shredding.

The apparatus may further comprise a controller configured to activate the means for shredding when the presence of the plasterboard has been detected by the sensing means. Such a feature would conserve power by deactivating the apparatus when it is not needed, thereby prolonging the life of the components.

In a second aspect of the invention, a system is provided for recycling shredded plasterboard strips. The system comprises means for crushing the shredded plasterboard strips, means for removing loose gypsum and means for removing waste paper.

Preferably, the means for removing loose gypsum is a mesh, the holes in the mesh being large enough to permit passage of loose gypsum particles through the mesh but small enough to restrict passage of waste paper. The mesh may be configured to further encourage the separation of the gypsum and the waste paper, for example by vibrating or moving rapidly back and forth to dislodge trapped gypsum particles.

A gypsum collection receptacle may be positioned underneath the mesh for collecting loose gypsum which has passed through the mesh. Alternatively, a chute may be provided underneath the mesh to transport the separated gypsum particles to a remote location.

In one embodiment, the mesh is configured as a conveyor belt. In this embodiment, whilst the gypsum and the paper are being separated by the mesh, they may also be being transported toward the means for crushing.

Preferably, the means for crushing the shredded plasterboard strips is a roller. The roller may be configured to crush the shredded plasterboard strips between the conveyor belt and the roller, thereby separating the gypsum from the paper. The roller may have a variety of configurations to promote separation. The roller may be positioned at different heights to provide different separation distances between the roller and the conveyor belt mesh to accommodate different thicknesses of waste. The height of the roller may be adjustable.

Preferably, the roller is textured. The roller may comprise a series of protrusions which exert different magnitudes of force on adjacent portions of the waste, thereby encouraging separation of the paper from a mass of gypsum by shear force.

After being crushed, more gypsum will have become dislodged from the paper. The conveyor belt mesh may be configured to separate the newly loosened gypsum from the waste paper which may then be collected in a receptacle as before.

Preferably, the means for removing waste paper is a plough configured to push the waste paper into a paper pulping receptacle. Alternative means for removing the waste paper are also possible, including allowing the paper to fall from the end of the conveyor belt into a receptacle.

The present invention also provides an aforementioned apparatus in combination with an aforementioned system. A conveyor belt system as described above could be integrated into a skip having a plasterboard shredder mounted across an opening, for example. In this embodiment, shredded plasterboard strips produced by the shredder could fall directly onto the conveyor belt mesh. Of course, the invention is not limited to the combination of these two embodiments and other embodiments are also envisaged.

In a third aspect of the invention, a process is provided for recycling plasterboard. The process comprises the steps of shredding plasterboard into strips, removing loose gypsum from the shredded plasterboard strips, crushing the plasterboard strips to separate the gypsum from the paper and removing the waste paper. The steps may be provided in this order or, alternatively, the steps of removing loose gypsum from the shredded plasterboard strips and crushing the plasterboard strips to separate the gypsum from the paper may be reversed or repeated as necessary.

In one particular embodiment, the process comprises the steps of shredding plasterboard into strips, removing loose gypsum from the shredded plasterboard strips, crushing the plasterboard strips to separate the gypsum from the paper, removing the separated gypsum and removing the waste paper.

Additional steps may also be provided. For example, if the step of shredding the plasterboard takes place at a remote location, such as a building site, a step of transporting the shredded plasterboard strips to a recycling plant may also be included. The step of transporting the waste between means for enacting each step may also be included. Furthermore, the step of recycling the gypsum and the paper after separation such that they may be reused may also be included.

Preferably, the step of shredding the plasterboard into strips comprises passing the plasterboard through an aforementioned apparatus. The step may further include the step of sensing a characteristic of the plasterboard prior to shredding and adjusting a means for shredding according to that characteristic. In one embodiment, the thickness of the plasterboard is sensed and, based on that thickness, the means for cutting is adjusted to accommodate the thickness and to shred the plasterboard into strips having a desired width.

Preferably, the step of removing loose gypsum comprises placing the shredded plasterboard strips on a mesh, the holes in the mesh being large enough to permit passage of loose gypsum particles through the mesh but small enough to restrict passage of waste paper. Optionally, the step of removing loose gypsum further comprises the step of vibrating the mesh to dislodge trapped gypsum particles.

The process may further comprise the step of collecting the gypsum in a gypsum collection receptacle positioned underneath the mesh.

If the process includes the step of transporting the waste between means for enacting each step, this step may comprise transporting the waste on the mesh, wherein the mesh is a configured as conveyor belt.

Preferably, the step of crushing the shredded plasterboard strips comprises passing the strips underneath a roller, thereby separating the gypsum from the paper. The strips may be crushed between the roller and the mesh conveyor belt, for example. This step may be followed by the step of removing the separated gypsum, in a similar way to that described above.

Preferably, the step of removing the waste paper comprises ploughing the paper into a paper pulping receptacle. Alternatively, the step may comprise allowing the waste paper to fall from the end of the mesh conveyor belt into a receptacle, for example.

By way of an example, four embodiments of an apparatus for shredding plasterboard waste according to the invention will be described. Furthermore, two embodiments of a system for recycling shredded plasterboard strips according to the invention and an embodiment of a process for recycling plasterboard according to the invention will each be described. The embodiments will be described with reference to the accompanying drawings, in which:

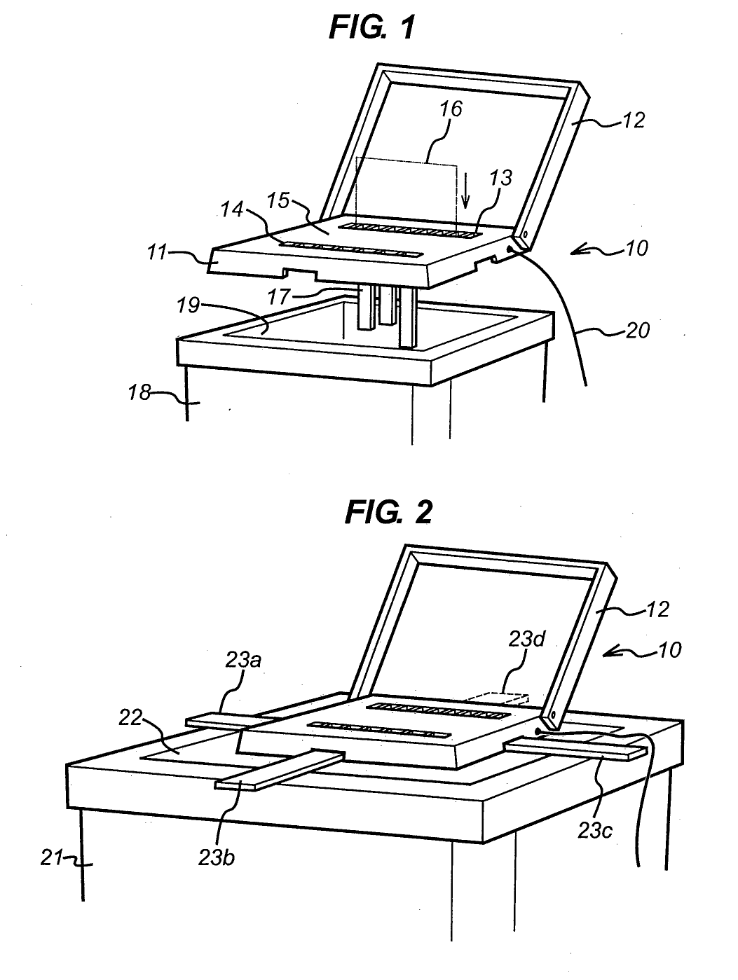

FIG. 1 shows a first embodiment of a plasterboard shredder in accordance with the invention configured for use with a first waste receptacle;

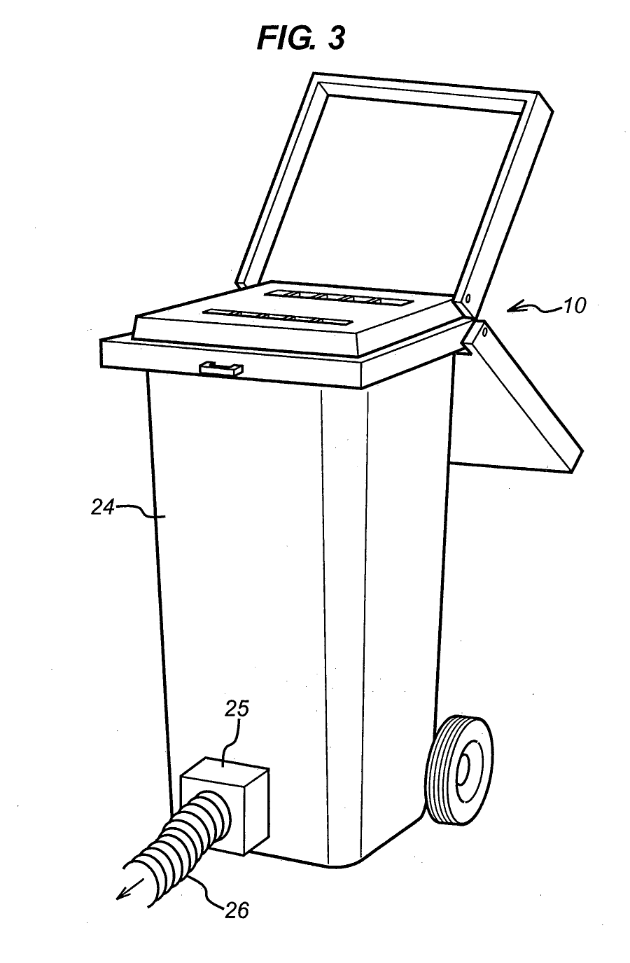

FIG. 2 shows the plasterboard shredder of FIG. 1 configured for use with a larger, second waste receptacle;

FIG. 3 shows the plasterboard shredder of FIG. 1 in use with a standard wheelie-bin which includes an extractor;

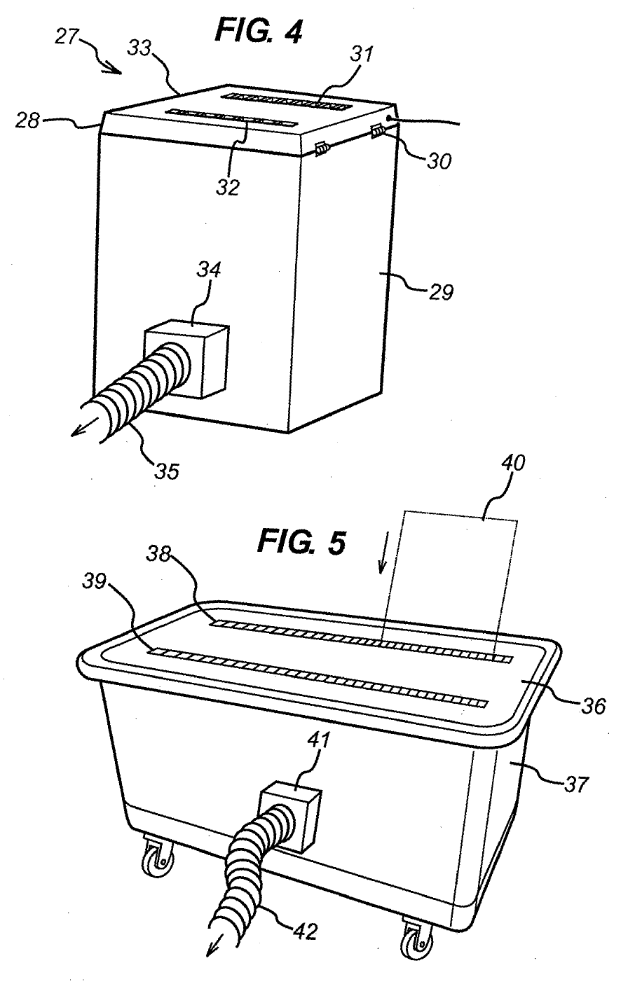

FIG. 4 shows a second embodiment of a plasterboard shredder in accordance with the invention, the shredder comprising a waste receptacle and an extractor;

FIG. 5 shows a third embodiment of a plasterboard shredder in accordance with the invention configured for use with an industrial sized bin;

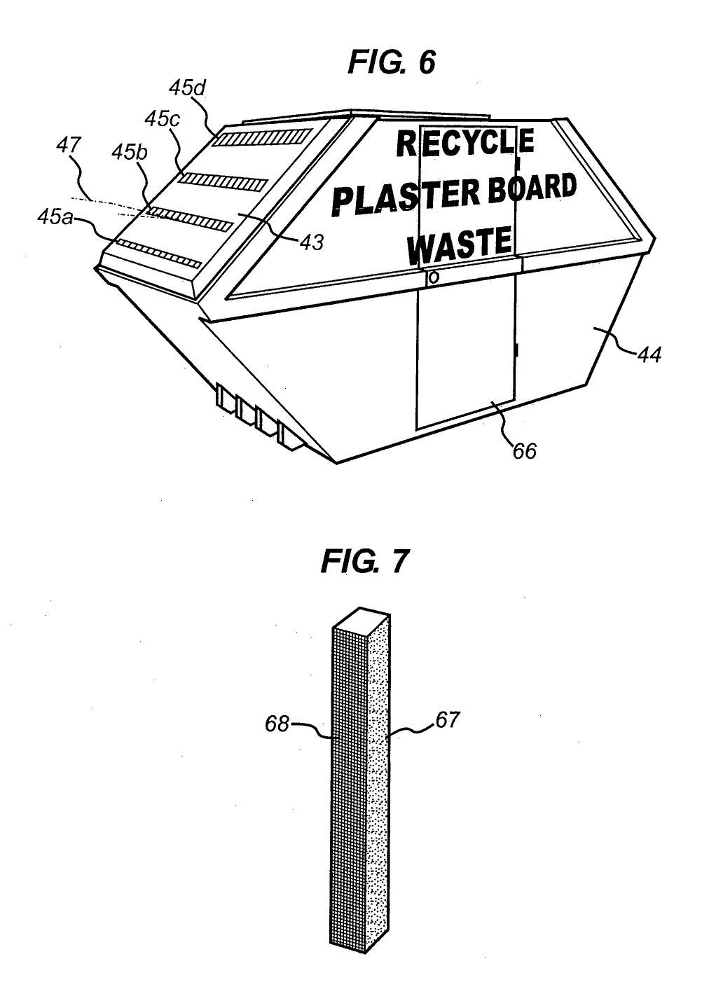

FIG. 6 shows a fourth embodiment of a plasterboard shredder in accordance with the invention configured for use with a skip;

FIG. 7 shows an example of a shredded plasterboard strip resulting from waste plasterboard being shredded by any of the plasterboard shredders shown FIG. 1 to FIG. 6;

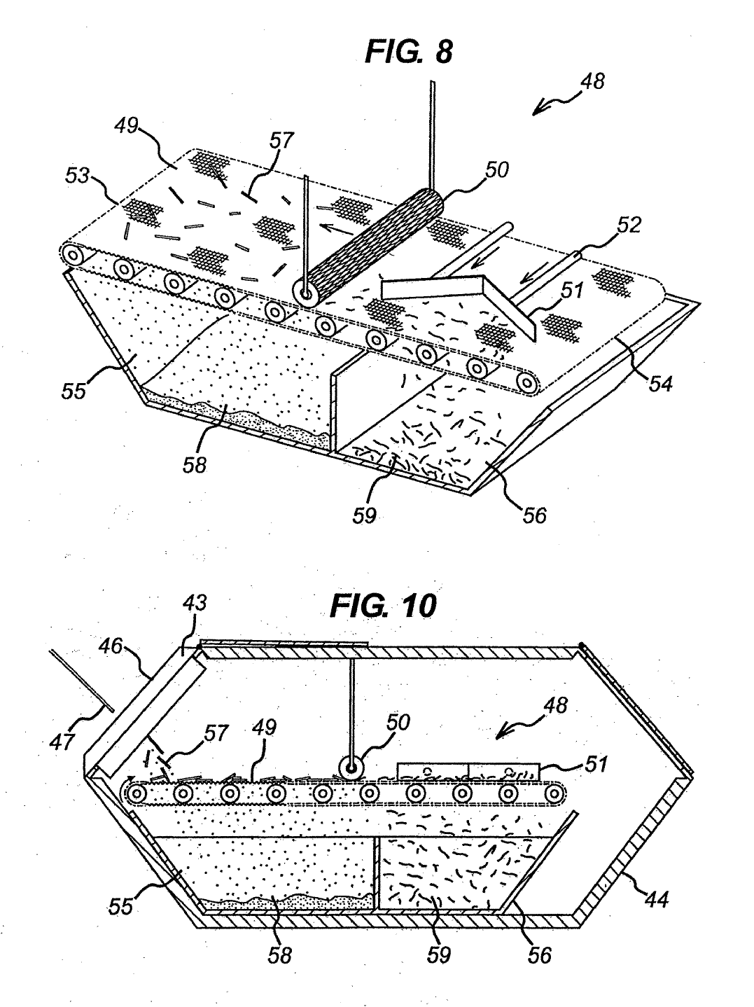

FIG. 8 shows a first embodiment of a system for recycling shredded plasterboard strips in accordance with the invention;

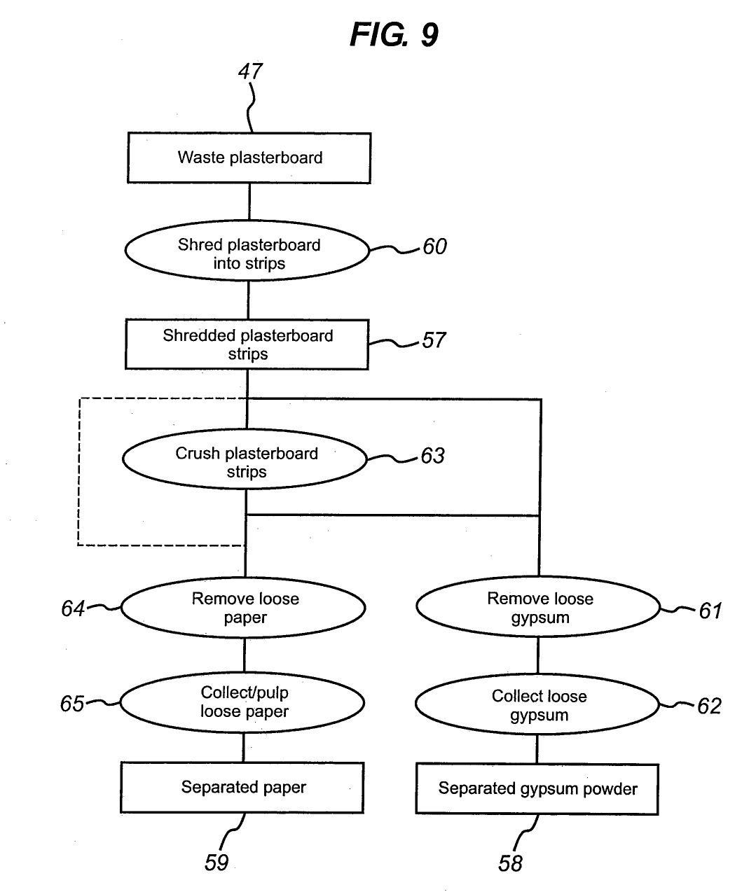

FIG. 9 shows a process for recycling plasterboard according to the invention:

FIG. 10 shows a second embodiment of a system for recycling shredded plasterboard strips in accordance with the invention configured for use inside the skip of FIG. 7; and

FIGS. 1 to 6 show embodiments of plasterboard shredders according to the present invention which are suitable for use at a work place such as a building site. Rather than collecting large pieces of plasterboard for disposal at a later stage, waste plasterboard created at a particular location on the building site may be fed into the shredders and the resulting shredded waste stored. The shredded waste will take up much less space than whole pieces and may be more easily collected and transported around the building site.

FIG. 1 shows a first embodiment of a plasterboard shredder 10 according to the present invention. The shredder comprises a base 11 and a lid 12 attached to the base 11 by hinges. The lid may be closed when the shredder is not in use.

The shredder comprises first and second openings 13 and 14 located at an upper surface 15 of the base 11, through which waste plasterboard 16 may be fed. In alternative configurations the openings may, of course, be positioned at different locations, for example at a side surface. In the embodiment of FIG. 1, the first and second openings 13 and 14, are configured to accept plasterboard of different thicknesses. The first opening 13 is wider than the second opening 14 and is configured to accept thicker plasterboard.

First and second shredding means (not shown) are positioned adjacent first and second openings 13 and 14 respectively. The shredding means are located inside the shredder 10. The shredding means are configured to shred the waste plasterboard 16 into waste plasterboard strips 17 of a particular width. In this embodiment, the first shredding means is configured to shred the plasterboard into narrower strips than the second shredding means.

Of course, more or fewer openings may be provided, each of which may or may not be configured to accept plasterboard of different thicknesses. Each opening may be adjacent a shredding means configured to shred the plasterboard into strips of a particular width, which may or may not be equal to the width of the strips produced by the other shredding means.

FIG. 1 shows the shredder 10 in use with a waste receptacle 18 having an opening 19. The shredder 10 is sized to fit over the opening 19 so that the shredded plasterboard strips 17 may be collected inside the waste receptacle 18.

A cable 20 provides electrical power to the shredder 10.

Once the waste receptacle 18 is full, the shredder 10 is removed and the shredded plasterboard strips 17, which have been collected in the receptacle 18, are transported away from the work place.

FIG. 2 shows the shredder 10 in use with a larger waste receptacle 21 having an opening 22. In this instance, means for attaching comprising four extendable legs 23a-d are provided to position the shredder 10 over the opening 22 of the larger receptacle 21. The extendable legs 23a-d are retractable within the shredder 10 and each may be extended perpendicular to one of the sides of the shredder 10 to a greater or lesser extent depending on the size of the bin or waste receptacle with which the shredder is being used.

Of course, other means for attaching may be used including, including, but not limited to, clips to attach the shredder to one or more sides of a bin or waste receptacle.

FIG. 3 shows the shredder 10 in use with a standard wheelie-bin 24. Attached to the wheelie-bin 24 is an extractor 25. A chute 26 is connected to the extractor 25. The extractor 20 is configured to remove waste materials including dust, loose gypsum particles and shredded plasterboard from the wheelie-bin 24 as it is placed therein. The waste materials removed from the wheelie-bin 24 are passed from the extractor 25 to the chute 26 which transports the waste materials to a remote location, such as a skip located elsewhere on the building site, possibly some storeys or floors below the shredder 10.

An alternative embodiment of a shredder according to the present invention is shown in FIG. 4. The shredder 27 comprises a lid 28 and a waste receptacle 29 which is attached to the lid 28 by hinges 30. As with the shredder of FIGS. 1 to 3, this shredder 27 comprises two openings 31 and 32 located at an upper surface 33 of the lid 28. The shredder 27 comprises two shredding means (not shown) adjacent the two openings 31 and 32.

As with the embodiment shown in FIGS. 1 to 3, plasterboard which is passed through one of the openings 31 and 32 is shredded into waste plasterboard strips which are collected in the waste receptacle 29. Once collected therein, the waste plasterboard strips may be removed from the receptacle 29 by opening the lid 28 and gaining access to the contents of the receptacle 29. Alternatively, waste may be removed by an extractor 34 attached to the receptacle 29 which is configured to pass waste collected therein to a chute 35. The chute 35 then transports the waste materials to a remote location, such as a skip located elsewhere on the building site.

FIGS. 5 and 6 show third and fourth embodiments of plasterboard shredders in accordance with the present invention. FIG. 5 shows a shredder 36 attached to an industrial sized bin 37. The shredder 36 is removable and is attached to the industrial sized bin 37 by attachment means (not shown) located around the periphery of the shredder 36. The shredder 36 comprises two openings 38 and 39 through which waste plasterboard 40 may be placed. The waste plasterboard strips which result are collected in the industrial sized bin 37. This embodiment of the invention may be used on large scale building sites, where a greater volume of plasterboard is used, or placed in a central location at a building site to shred and store all waste plasterboard generated at the site. As with previous embodiments, an extractor 41 and a chute 42 may be attached to the industrial sized bin 37 to transport waste collected therein to a remote location.

FIG. 6 shows a shredder 43 attached to a skip 44. The shredder 43 is removable and is attached to the skip 44 by attachment means (not shown) located around the periphery of the shredder 43. Alternatively, the shredder may be permanently fixed to the skip 44. A door 66 in the skip 44 is provided to gain access to the shredded plasterboard waste inside. The shredder 43 comprises four openings 45a-d which are configured to accept different thicknesses of plasterboard 47. Of course, more or fewer openings may be provided.

The skip 44 may be positioned centrally in a building site and used to shred all of the waste plasterboard generated at the site. The skip 44 may form part of a plasterboard recycling scheme wherein an external company provides the skip 44 and the shredder 43, and periodically collects the shredded plasterboard waste stored inside the skip 44 and removes it for recycling.

FIG. 8 shows an embodiment of a system for recycling shredded plasterboard waste. The system will now be described in detail with reference to a method for recycling shredded plasterboard waste, as shown in a flow diagram at FIG. 9.

The system 48 comprises a mesh conveyor belt 49, a roller 50 and a plough 51 moveable across the conveyor belt 49 by actuation means 52. The conveyor belt 49 has a first end 53 and a second end 54. A portion of the mesh conveyor belt 49, proximate the first end 53, is positioned above a gypsum collection receptacle 55.

The mesh conveyor belt 49 comprises holes which are sized such that loose gypsum particles 58 may pass through the mesh but larger waste including paper may not. The holes may be between 1 mm and 10 mm in diameter, for example.

Before plasterboard material reaches the recycling system 48 of FIG. 8, the waste plasterboard is shredded into strips (step 60). Shredding could be performed by any one of the plasterboard shredders of FIGS. 1 to 6, for example.

During operation of the system 48 of FIG. 8, the shredded plasterboard waste 57 is placed on the first end 53 of the conveyor belt 49. Loose gypsum particles 58 will immediately be removed (step 61) by passing through the holes in the mesh and will be collected (step 62) in the gypsum collection receptacle 55 underneath.

Even after shredding, it is likely that much of the gypsum will still be sandwiched between the sheets of paper. The system 48 therefore provides a roller 50 for crushing (step 63) the shredded plasterboard strips 57 against the conveyor belt 49. This process separates the remaining gypsum from the paper, as will now be described.

The combination of shredding the plasterboard into strips (step 60) and crushing the plasterboard strips (step 63) ensures that all of the gypsum is removed from the paper and that no material is irrecoverably wasted—as may be the case, for example, with other processing means such as pulverising.

As shown in FIG. 7, shredded strips will comprise a packed core of agglomerated gypsum 67 sandwiched on two opposing sides by sheets of paper 68. When placed on the conveyor belt, strips will be oriented to the roller in a number of ways. The strips may, for example, lie with the faces of the paper sheets being tangential to a surface portion of the roller, the entire surface of one sheet thereby coming into contact with the roller. Alternatively, they may lie with the faces of the paper sheets being perpendicular to a surface portion of the roller, one edge of each sheet thereby coming into contact with the roller. Regardless of orientation, however, the roller will ensure separation of the paper from the gypsum and ensure the gypsum is de-agglomerated.

As a strip passes underneath the roller, the roller compresses the strip between the roller and the surface beneath the strip (which, in the present embodiment is a mesh conveyor belt). In the case of the first example, where the whole surface of the paper sheet comes into contact with the roller, the roller will deform the surface, placing more pressure on the portion of the paper directly underneath the roller than on the portions immediately adjacent to it. This imbalance of linear forces will result in a shear force, pulling the adjacent portions of the paper toward the roller thereby separating the paper from the gypsum. The compressive force provided by the roller will separate the agglomerated gypsum particles and will be transferred to the other sheet of paper which will be separated by shear forces in a similar manner to the separation of the first sheet.

In the case of the second example, where the edges of the sheets are contacted, the roller will compress the agglomerated gypsum particles, thereby encouraging their separation and forcing them to expand laterally (i.e. perpendicular to the direction of compression). Collectively, the gypsum particles will exert a force on the two sheets of paper, as a result of the expansion, which will be greatest at points equidistant between the two sheets. The imbalance of linear forces acting across the sheets results in a shear force which, as with scenario 1, will separate the paper from the gypsum.

In each case, the gypsum is separated from the paper and is deagglomerated into loose gypsum particles which may pass through the holes in the mesh. The paper remains in relatively large strips which will not pass through the mesh and may be collected at a later stage. The above described process provides effective separation of the two constituent components without destroying either one of them such that they may both be recovered and recycled.

Referring back to FIG. 8, the roller 50 is positioned above the gypsum collection receptacle 55. After the remaining gypsum has been removed from the paper by the roller 50, more loose gypsum particles 58 will be removed (step 61) by passing through the mesh conveyor belt 49 and will be collected (step 62) in the gypsum collection receptacle 55. Waste paper 59 remains on the conveyor belt 49 and proceeds towards the second end 54.

A portion of the mesh conveyor belt 49, proximate the second end 54, is positioned above a paper collection receptacle 56 which extends beyond one side of the conveyor belt 49. As the waste paper 59 approaches the second end 54 of the conveyor belt, the waste paper 59 is removed (step 64) by being pushed from the conveyor belt 49 by the plough 51. The plough 51 is moved back and forth across the conveyor belt 49 by the actuation means 52 and ensures that all waste paper 59 is caught. The waste paper 59 is then collected (step 65) in the paper collection receptacle 56.

Once collected in the gypsum collection receptacle 55 and the paper collection receptacle 56, the constituent components of the plasterboard may be collected and recycled. Alternatively, receptacles may themselves comprise recycling means such that the recovered materials are recycled ready for further use.

Finally, FIG. 10 shows an embodiment of the invention wherein the system 48 of FIG. 8 is disposed inside the skip 44 of FIG. 6, such that waste plasterboard 47 may be shredded by the shredder 43 and the resulting waste plasterboard strips 57 may fall from the shredder 43 directly onto the mesh conveyor belt 49 at which point the above described method for recycling plasterboard begins. The skip 44 comprises a door to enable access to the gypsum collection receptacle 55 and the paper collection receptacle 56 to collect the separated components.

It will be understood that the present invention has been described by way of example and that modifications of detail can be made within the scope of the appended claims.

1. An apparatus for shredding plasterboard waste, the apparatus comprising:
at least one opening into which waste plasterboard may be placed; and
means for shredding the waste plasterboard placed in the opening.

2. An apparatus as claimed in claim 1, further comprising means for attaching the apparatus to a waste receptacle so that shredded plasterboard may be collected therein.

3. An apparatus as claimed in claim 2, wherein the means for attaching is adjustable and may be adjusted to attach the apparatus to different sizes of waste receptacle.

4. An apparatus as claimed in claim 1, wherein the apparatus is configured to be supported over an opening in a waste receptacle.

5. An apparatus as claimed in claim 2, further comprising an extractor attachable to a waste receptacle and configured to remove the shredded plasterboard waste to a remote location.

6. An apparatus as claimed in claim 2, further comprising a waste receptacle for collecting the shredded plasterboard.

7. An apparatus as claimed in claim 6, wherein the waste receptacle is a skip.

8. An apparatus as claimed in claim 6, wherein the waste receptacle is a wheelie bin.

9. An apparatus as claimed in claim 2, further comprising a chute attached to the apparatus and configured to transport the shredded plasterboard waste to a remote location.

10. An apparatus as claimed in claim 1, wherein the at least one opening comprises a first opening capable of receiving plasterboard having a first thickness and a second opening capable of receiving plasterboard having a second thickness, the second thickness being different to the first thickness.

11. An apparatus as claimed in claim 1, wherein the at least one opening is designed to accept plasterboard having a thickness selected from the group of 9.5 mm, 12.5 mm, 15 mm and 19 mm.

12. An apparatus as claimed in claim 1, further comprising:
sensing means for sensing a characteristic of a plasterboard placed in the at least one opening.

13. An apparatus as claimed in claim 12, wherein the characteristic is the thickness of the plasterboard placed in the opening, the apparatus further comprising a controller configured to activate a warning device when the thickness of the plasterboard is incompatible with the opening in which it is placed.

14. An apparatus as claimed in claim 12, further comprising a controller configured to activate the means for shredding when the presence of the plasterboard has been detected by the sensing means.

15. An apparatus as claimed in claim 1, wherein the shredding means is configured to shred the plasterboard into strips.

16. An apparatus as claimed in claim 15, wherein the width of the strips is between about 5 mm and about 50 mm.

17. A system for recycling shredded plasterboard strips, the system comprising:
means for crushing the shredded plasterboard strips;
means for removing loose gypsum; and
means for removing waste paper.

18. A system as claimed in claim 17, wherein the means for removing loose gypsum is a mesh, the holes in the mesh being large enough to permit passage of loose gypsum particles through the mesh but small enough to restrict passage of waste paper.

19. A system as claimed in claim 18, further comprising a gypsum collection receptacle positioned underneath the mesh for collecting loose gypsum which has passed through the mesh.

20. A system as claimed in claim 18, wherein the mesh is configured as a conveyor belt.

21. A system as claimed in claim 17, wherein the means for crushing the shredded plasterboard strips is a roller.

22. A system as claimed in claim 21, wherein the roller is configured to crush the shredded plasterboard strips between a conveyor belt operable therewith and the roller, thereby separating the gypsum from the paper.

23. A system as claimed in claim 17, wherein the means for removing waste paper is a plough configured to push the waste paper into a paper pulping receptacle.

24. (canceled)

25. A process for recycling plasterboard comprising the steps of:
shredding plasterboard into strips:
removing loose gypsum from the shredded plasterboard strips:
crushing the plasterboard strips to separate the gypsum from the paper; and
removing the waste paper.

26. A process as claimed in claim 25, wherein the step of shredding the plasterboard into strips comprises passing the plasterboard through shredding means.

27. A process as claimed in claim 25, wherein the step of removing loose gypsum comprises placing the shredded plasterboard strips on a mesh, the holes in the mesh being large enough to permit passage of loose gypsum particles through the mesh but small enough to restrict passage of waste paper.

28. A process as claimed in claim 27, further comprising the step of collecting the gypsum in a gypsum collection receptacle positioned underneath the mesh.

29. A process as claimed in claim 25, wherein the step of crushing the shredded plasterboard strips comprises passing the strips underneath a roller, thereby separating the gypsum from the paper.

30. A process as claimed in claim 25, wherein the step of removing the waste paper comprises ploughing the paper into a paper pulping receptacle.

31. (canceled)
